(19) United States
(12) Patent Application Publication
(10) Pub. No.: US 2020/0344838 A1
(43) Pub. Date: Oct. 29, 2020

(54) TECHNIQUES FOR MAINTAINING CONNECTED STATE

(71) Applicant: Qualcomm incorporated, San Diego, CA (US)

(72) Inventors: Peng Wu, Shanghai (CN); Nan Zhang, Beijing (CN); Jiming Guo, Beijing (CN); Arnaud Meylan, San Diego, CA (US)

(21) Appl. No.: 16/958,853

(22) PCT Filed: Dec. 29, 2017
(86) PCT No.: PCT/CN2017/119740

§ 371 Date: Jun. 29, 2020

(51) Int. Cl. H04W 76/25; H04W 28/24; H04W 76/28

(52) U.S. Cl. CPC H04W 76/25; H04W 76/28; H04W 28/24

(57) ABSTRACT

Methods, systems, and devices for wireless communications are described. A user equipment (UE) may run a process associated with a low latency. As such, the UE may operate in a mode to stay in a connected state with a network. The mode may include transmitting a keep alive message. Such message may be transmitted based in part on a keep alive timer with a shorter duration than a network traffic inactivity timer. If no communications occur between the UE and the network by the expiration of the keep alive timer, the UE may transmit a keep alive message to the network to maintain the connected state and reset the keep alive timer. Alternatively, if communications do occur, the UE may reset the keep alive timer. If the process is terminated, the UE may exit the mode for staying in the connected state, which may include canceling the keep alive timer.

### CROSS REFERENCE

The present Application is a 371 national phase filing of International Patent Application No. PCT/CN2017/119740 by Wu et al., entitled “TECHNIQUES FOR MAINTAINING CONNECTED STATE,” filed Dec. 29, 2017, assigned to the assignee hereof.

### BACKGROUND

This application relates to wireless communication methods and apparatus, and more particularly to techniques for maintaining connected state (e.g., maintaining connected mode state).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

Some wireless devices, such as UEs or base stations, may transmit or receive Internet Protocol (IP) packets (e.g., voice data, video data, or other web data) that are established at the IP layer of the protocol stack supported by the wireless device. In some instances, if packets are not being transmitted or received for a certain amount of time, the wireless device may enter an idle state (e.g., to conserve power). However, being in an idle state may not be ideal if the wireless device is running a process and/or operating an application that benefits from on-going low latency communications (e.g., transmissions or receptions). For example, the wireless device may receive a packet (e.g., from the Application Layer of the protocol stack) to be transmitted relatively quickly (e.g., a low latency packet). If the wireless device is in the idle state, however, a connected mode may need to be reestablished prior to transmission of the low latency packet, which may result in a delay in transmission of the packet (e.g., due to the latency associated with connection reestablishment procedures or any delay in establishing connection). More efficient communication techniques may be desirable in such scenarios to mitigate or prevent delays resulting from connection reestablishment after a wireless device has entered an idle state.

### SUMMARY

The described techniques relate to improved methods, systems, devices, or apparatuses that support techniques for maintaining connected state. Generally, the described techniques provide for running a process associated with a quality of service type at a user equipment (UE), operating in a mode for the quality of service type to stay in a connected state between the UE and a network, and transmitting a keep alive message to stay in the connected state. In some cases, the keep alive message may have a keep alive timer associated with it, where the keep alive timer has a shorter duration than a network traffic inactivity timer, an inactivity timer associated with a discontinuous reception (DRX) cycle, or less than a DRX cycle (e.g., less than a sub-cycle length within a DRX cycle). If no communications occur between the UE and the network by the expiration of the keep alive timer (e.g., before the network traffic inactivity timer ends), the UE may transmit an additional keep alive message to the network in order to maintain the connected state and reset the keep alive timer. Additionally or alternatively, if a communication between the UE and the network does occur, the UE may reset the keep alive timer. In some cases, if the process is paused or terminated, the UE may exit the mode for staying in the connected state, which may include canceling operation of the keep alive timer.

A method of wireless communications is described. The method may include identifying that the UE is running a process that is associated with a quality of service type, operating in a mode for maintaining a connected state between the UE and a network based on the quality of service type, and transmitting, to the network, a keep alive message based on operation of the UE in the mode, where the keep alive message ensures that a radio connection between the UE and the network remains available.

An apparatus for wireless communications is described. The apparatus may include means for identifying that the UE is running a process that is associated with a quality of service type, means for operating in a mode for maintaining a connected state between the UE and a network based on the quality of service type, and means for transmitting, to the network, a keep alive message based on operation of the UE in the mode, where the keep alive message ensures that a radio connection between the UE and the network remains available.

Another apparatus for wireless communications is described. The apparatus may include a processor, memory in electronic communication with the processor, and instructions stored in the memory. The instructions may be operable to cause the processor to identify that the UE is running a process that is associated with a quality of service type, operate in a mode for maintaining a connected state between the UE and a network based on the quality of service type, and transmit, to the network, a keep alive message based on operation of the UE in the mode, where the keep alive message ensures that a radio connection between the UE and the network remains available.

A non-transitory computer-readable medium for wireless communications is described. The non-transitory computer-readable medium may include instructions operable to cause a processor to identify that the UE is running a process that is associated with a quality of service type, operate in a mode for maintaining a connected state between the UE and a network based on the quality of service type, and transmit, to the network, a keep alive message based on operation of the UE in the mode, where the keep alive message ensures that a radio connection between the UE and the network remains available.

Some examples of the method, apparatus, and non-transitory computer-readable medium described above may further include processes, features, means, or instructions for identifying an absence of communications over the radio connection between the UE and the network for a first amount of time. Some examples of the method, apparatus, and non-transitory computer-readable medium described above may further include processes, features, means, or instructions for transmitting one or more additional keep alive messages based on the absence of communications.

In some examples of the method, apparatus, and non-transitory computer-readable medium described above, transmitting the keep alive message includes transmitting, to the network, at least one of an activity ping, a dummy packet data convergence protocol (PDCP) protocol data unit (PDU), fake data, a scheduling request (SR), or combinations thereof.

In some examples of the method, apparatus, and non-transitory computer-readable medium described above, identifying that the UE may be running the process includes monitoring the process at an AP layer or at a modem layer and determining the quality of service type associated with the process.

In some examples of the method, apparatus, and non-transitory computer-readable medium described above, identifying that the UE may be running the process includes receiving an indication that the UE may be running the process via a low latency service API.

Some examples of the method, apparatus, and non-transitory computer-readable medium described above may further include processes, features, means, or instructions for generating a dummy PDCP PDU on an interface for transmission as the keep alive message.

In some examples of the method, apparatus, and non-transitory computer-readable medium described above, the quality of service type includes a communications latency level that may satisfy (e.g., be below) a latency threshold.

In some examples of the method, apparatus, and non-transitory computer-readable medium described above, the communications latency level, the latency threshold, or both may be associated with mobile terminated traffic.

Some examples of the method, apparatus, and non-transitory computer-readable medium described above may further include processes, features, means, or instructions for initiating a keep alive timer at a time of the transmission.

In some examples of the method, apparatus, and non-transitory computer-readable medium described above, the keep alive timer may have a period that may be less than a network traffic inactivity time period.

In some examples of the method, apparatus, and non-transitory computer-readable medium described above, the keep alive timer may have a period that is less than an inactivity timer associated with a DRX cycle.

In some examples of the method, apparatus, and non-transitory computer-readable medium described above, the keep alive timer has a period that is less than a DRX cycle (e.g., a sub-cycle length within a DRX cycle such that a UE may enter an awake state a plurality of times in a DRX cycle).

Some examples of the method, apparatus, and non-transitory computer-readable medium described above may further include processes, features, means, or instructions for identifying an absence of communications from the UE to the network during a duration of the keep alive timer. Some examples of the method, apparatus, and non-transitory computer-readable medium described above may further include processes, features, means, or instructions for transmitting an additional keep alive message to the network upon expiration of the keep alive timer. Some examples of the method, apparatus, and non-transitory computer-readable medium described above may further include processes, features, means, or instructions for resetting the keep alive timer upon transmission of the additional keep alive message.

Some examples of the method, apparatus, and non-transitory computer-readable medium described above may further include processes, features, means, or instructions for identifying a presence of communications between the UE and the network during a duration of the keep alive timer. Some examples of the method, apparatus, and non-transitory computer-readable medium described above may further include processes, features, means, or instructions for resetting the keep alive timer based on the presence of communications between the UE and the network.

Some examples of the method, apparatus, and non-transitory computer-readable medium described above may further include processes, features, means, or instructions for identifying that the process may have paused or terminated. Some examples of the method, apparatus, and non-transitory computer-readable medium described above may further include processes, features, means, or instructions for exiting the mode for maintaining the connected state between the UE and the network. Some examples of the method, apparatus, and non-transitory computer-readable medium described above may further include processes, features, means, or instructions for receiving, from an API, an indication of a mode change for maintaining the connected state. Some examples of the method, apparatus, and non-transitory computer-readable medium described above may further include processes, features, means, or instructions for exiting the mode for maintaining the connected state between the UE and the network.

### BRIEF DESCRIPTION OF THE DRAWINGS

FIG. 1 illustrates an example of a system for wireless communications that supports techniques for maintaining connected state in accordance with aspects of the present disclosure.

FIG. 2 illustrates an example of a wireless communications system that supports techniques for maintaining connected state in accordance with aspects of the present disclosure.

FIGS. 3 and 4 illustrate examples of timelines that support techniques for maintaining connected state in accordance with aspects of the present disclosure.

FIG. 5 illustrates an example of a process flow that supports techniques for maintaining connected state in accordance with aspects of the present disclosure.

FIGS. 6 through 8 show block diagrams of a device that supports techniques for maintaining connected state in accordance with aspects of the present disclosure.

FIG. 9 illustrates a block diagram of a system including a user equipment (UE) that supports techniques for maintaining connected state in accordance with aspects of the present disclosure.

FIGS. 10 and 11 illustrate methods for techniques for maintaining connected state in accordance with aspects of the present disclosure.

### DETAILED DESCRIPTION

A wireless communications system (e.g., a long term evolution (LTE) or LTE-Advanced (LTE-A) system, an LTE-Pro system, a new radio (NR) system) may employ techniques to maintain a connected state for a wireless device, such as a user equipment (UE) or a base station. Maintaining the connected state may involve preventing the wireless device from entering an idle state or mode by sending a “keep alive” message. In some cases, the “keep alive” message may include a dummy packet (e.g., Protocol Data Units (PDUs)) generated by a Packed Data Convergence Protocol (PDCP) layer within a protocol stack supported by the wireless device, an activity ping, fake data, an SR, or a combination thereof. The “keep alive” message may be transmitted periodically at a period that is less than an inactivity timer that would otherwise cause the wireless device to enter an idle state or mode should no packets be exchanged prior to expiration of the inactivity timer.

The transmission of the “keep alive” message may be enabled or disabled based on conditions or application specific parameters currently being operated at the wireless device. For instance, an application processor (AP) layer or a modem layer of the Internet Protocol (IP) layer may monitor for a trigger (e.g., an operating parameter, a specific application, a quality of user experience type) that may be used to enable the transmission of the “keep alive” message that prevents the wireless device from entering an idle mode. If a trigger is observed, the AP or modem layer may then send a command to the PDCP layer to enable a “keep connection mode state” at the wireless device causing the PDCP layer to generate dummy PDCP PDUs to send to the network (e.g., via an internet evolved packet system (EPS) bearer). The PDCP layer may also start a “keep alive” timer at about the same time as sending the “keep alive” message to the network. The “keep alive” timer may be set based on a network traffic inactivity timer such that the “keep alive” timer expires before the network traffic inactivity timer. In one example, the network traffic inactivity timer may be preconfigured or set by the network to be 10 seconds or more. In such cases, the “keep alive” timer may be set to 9 seconds or less. Additionally or alternatively, the keep alive message may be transmitted at such times that an inactivity timer associated with a discontinuous reception (DRX) cycle does not expire or such that the UE enters shortened awake and sleep states of the DRX cycle and/or such that the UE enters an awake state a few times during the DRX cycle. At the time of expiration of the “keep alive” timer, the PDCP layer will generate a subsequent “keep alive” message, send it to the network (e.g., via the internet EPS bearer), and reset the “keep alive” timer.

If actual user data (e.g., non-dummy data) is received at the PDCP layer (e.g., from the IP layer to be transmitted to the network) between generation and transmission of subsequent “keep alive” messages, the PDCP layer will reset the “keep alive” timer. Further, there may be a trigger (e.g., an operating parameter change, a lack of specific application, disable command) that may be used to disable or deactivate the “keep connection mode state” at the wireless device. For instance, the AP or Data Services (DS) layer may observe that a specific application that triggered activation of the “keep connection mode state” is no longer operating on the wireless device and may therefore send a command to the PDCP layer to disable the “keep connection mode state” at the wireless device. After receipt of such a command, the PDCP layer may stop the “keep alive” timer and cease generation of “keep alive” messages.

Aspects of the disclosure are initially described in the context of a wireless communications system. An additional wireless communications system, a timeline, and a process flow are further provided to describe aspects of the present disclosure. Aspects of the disclosure are further illustrated by and described with reference to apparatus diagrams, system diagrams, and flowcharts that relate to techniques for maintaining connected mode state.

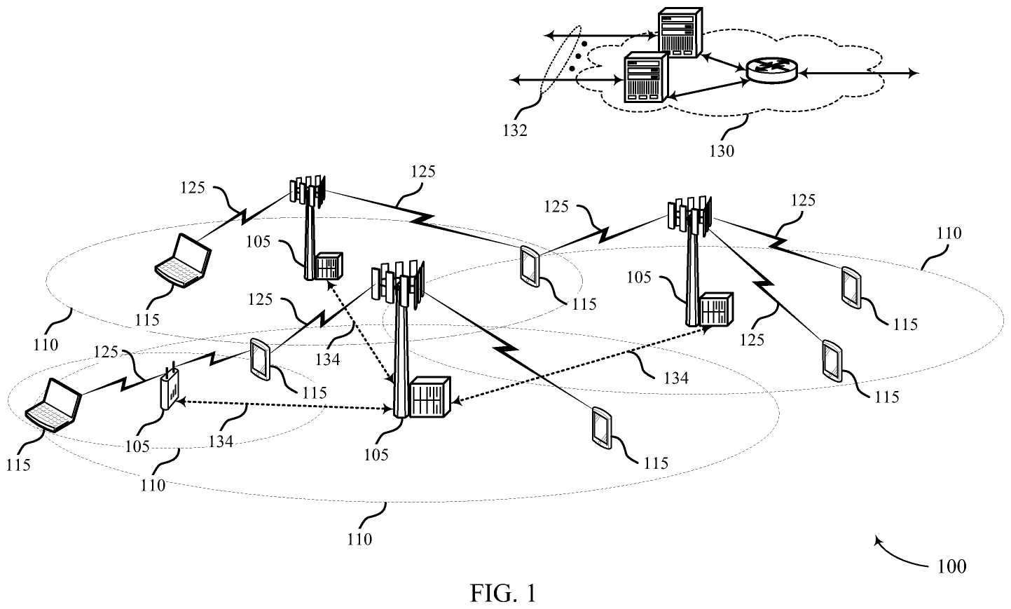

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE network, an LTE-A network, an LTE-A Pro network, or an NR network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, IP connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based on listening according to different receive beam directions (e.g., a beam direction determined to have a highest signal strength, highest signal-to-noise ratio, or otherwise acceptable signal quality based on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or PDCP layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ= 1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

Wireless communications system 100 may include UEs 115 that support applications such as multiplayer gaming, social gaming, social media applications, etc. The user experience quality of these applications (and others) may depend on the latency (e.g., IP latency) associated with wireless communications with a serving base station 105. This dependency on latency may be seen in, for example, a game where a user posts a packet to a group and challenges other users to “grab” the packet as quickly as possible. In order to “grab” the packet, a UE 115 may be notified that the packet was posted (e.g., via a mobile terminated message), and the UE 115 may transmit signaling to a base station 105 to “grab” the packet (e.g., via a mobile originated message). In this example, a user's ability to compete with other users may depend on the latency associated with receiving the notification that the packet was posted and transmitting the signaling to “grab” the packet. Thus, as can be understood from this example, low latency services at a UE 115 may be desirable in wireless communications system 100.

Wireless communications system 100 may support low latency communications between a UE 115 and a base station 105 to improve the quality of processes and/or applications running on the UE 115, such as on an AP layer or modem layer (e.g., DS layer). The AP layer may include or run a high level operating system (HLOS), which may support other components. For instance, an application programming interface (API) may run on the AP layer or modem layer and support tools for interacting with a user and other components of the UE 115 to support low latency services. In some cases, the API may receive a request to operate in a low latency mode from, for example, an application or a user and the API may configure the low latency mode of operation based on receiving the request. Additionally or alternatively, the UE 115 may monitor if the application is running at the AP layer or modem layer and determine to operate in the low latency mode based on the presence of the application. The low latency mode may include the UE 115 transmitting a keep alive message to maintain a radio connection between the UE 115 and the base station 105. The keep alive message may be transmitted at such times that a network inactivity timer between the UE 115 and the base station 105 does not expire and the radio connection is not lost. Additionally or alternatively, the keep alive message may be transmitted at such times that an inactivity timer associated with a DRX cycle does not expire or such that the UE 115 enters shortened awake and sleep states of the DRX cycle, and/or such that the UE 115 enters an awake state a few times during the DRX cycle.

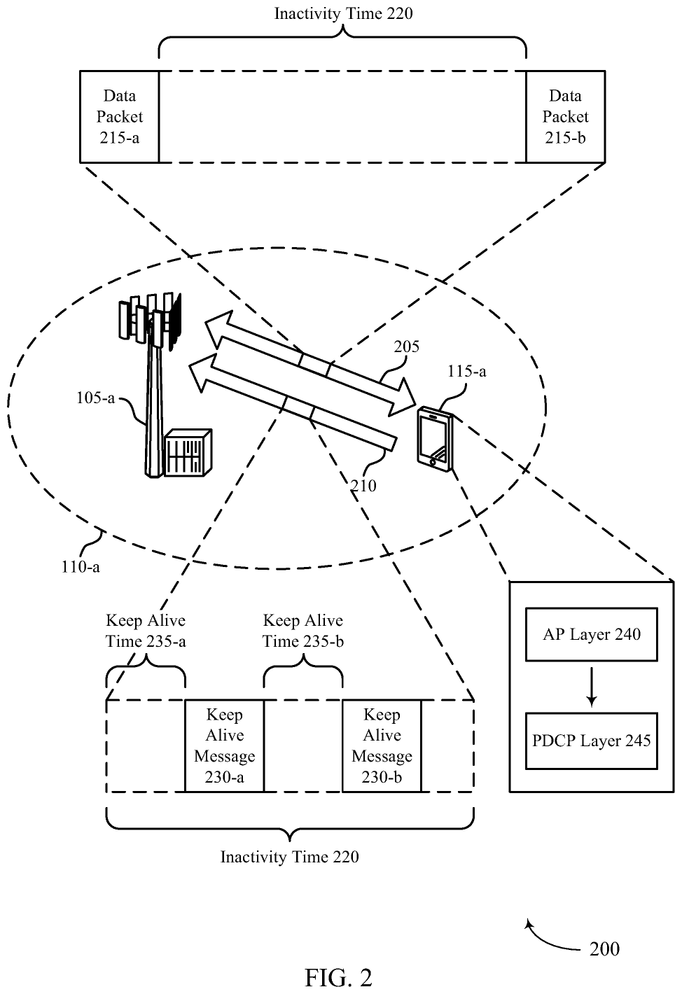

FIG. 2 illustrates an example of a wireless communications system 200 that supports techniques for maintaining connected state in accordance with various aspects of the present disclosure. In some examples, wireless communications system 200 may implement aspects of wireless communication system 100. Wireless communications system 200 may include a UE 115-a and a base station 105-a, which may be examples of UEs 115 and base stations 105 as described with reference to FIG. 1. Base station 105-a may provide communication coverage for a coverage area 110-a. Wireless communications system 200 may support low latency communications between base station 105-a and UE 115-a on resources of carriers 205 and 210. In some cases, maintaining a connected state may further include periodically waking up from a DRX sleep state, waking up from a DRX sleep state a plurality of times, or avoiding the DRX sleep state.

UE 115-a may support a power saving mode which may allow UE 115-a to save power by entering an idle state or mode. In some cases, base station 105-a may transmit a downlink transmission (e.g., a mobile terminated message) to UE 115-a when UE 115-a is in an idle state or mode. In such cases, UE 115-a may transition to a connected state or mode to receive the downlink message. Specifically, UE 115-a may transition to the connected state or mode after receiving a paging message from base station 105-a. However, in some cases, UE 115-a may have to wait a relatively significant amount of time (e.g., tens or hundreds of milliseconds) before receiving the paging message (e.g., a few seconds). Additionally, during the transition, UE 115-a may establish a connection with base station 105-a which may take an additional amount of time (e.g., hundreds of milliseconds). Thus, the latency associated with transitioning from an idle state or mode to a connected state or mode may be high.

Further, UE 115-a may support a DRX cycle which may also allow UE 115-a to save power by entering a sleep mode. In some cases, UE 115-a may have data to transmit to base station 105-a (e.g., mobile originated messages) or base station 105-a may have data to transmit to UE 115-a (e.g., mobile terminated messages), and UE 115-a may be in a sleep mode. In such cases, UE 115-a may wait to transition out of the sleep mode (e.g., wake up) before it can transmit or receive the data. Additionally, for a downlink transmission, base station 105-a may wait for an ON duration (e.g., at the beginning) of a subsequent DRX cycle to send the transmission, which may increase latency (e.g., may take 320 ms or more). The time taken to transition out of the sleep mode may depend on the duration of a DRX cycle supported by UE 115-a, and, in some cases, it may take a significant amount of time for UE 115-a to wake up and communicate with base station 105-a (e.g., hundreds of milliseconds). Thus, the latency associated with transitioning out of a sleep mode or waiting for a next DRX ON duration may be high.

Wireless communications system 200 may support efficient techniques for reducing the latency associated with communications between UE 115-a and base station 105-a. UE 115-a may initially transmit or receive data packets 215 (e.g., IP packets) with base station 105-a on resources of carrier 205 as part of running a low latency application. For example, the application may be associated with a quality of user experience type (e.g., a quality of service type) that benefits from low latency communications. To reduce the latency, UE 115-a may transmit one or more keep alive messages 230 (e.g., on a PDCP layer) to base station 105-a on carrier 210 as part of a mode for maintaining a connected state in order to prevent UE 115-a from entering an idle or sleep mode as described above.

In some cases, keep alive messages 230 may include a dummy packet (e.g., PDUs) from an IP layer to a PDCP layer within a protocol stack supported by UE 115-a, an activity ping, fake data, an SR, or a combination thereof. Additionally or alternatively, keep alive messages 230 may include a dummy MAC packet or a dummy scheduling request (SR) packet. For example, the dummy SR packet may first trigger an SR. Consequently, UE 115-a may ignore a physical uplink shared channel (PUSCH) grant for a buffer status report (BSR); report a BSR with zero bytes of data; report a BSR with one byte of data and transmit a message on a PUSCH sending one byte of data of MAC padding; or report a BSR with one byte of data and transmit a message on a PUSCH sending one fake one byte of a data radio bearer (DRB) MAC PDU or a fake RLC PDU or a PDCP fake PDU. Keep alive messages 230 may be transmitted periodically at a period that is less than an inactivity timer that would otherwise cause UE 115-a to enter an idle state or mode should no packets be exchanged prior to expiration of the inactivity time. In some cases, the inactivity timer may correspond to an RRC inactivity timer (e.g., for maintaining an RRC connected mode state) and be configured by base station 105-a. Additionally or alternatively, the inactivity timer may correspond to a drxInactivityTimer (e.g., for monitoring PDCCH during DRX operation or periodically waking up from or avoiding the DRX sleep state), where the expiration of the drxInactivityTimer is known to UE 115-a and base station 105-a.

The transmission of keep alive messages 230 may be enabled or disabled based on conditions or application specific parameters currently being operated at UE 115-a. For instance, UE 115-a may include an AP layer or a modem layer (e.g., AP layer 240) that may monitor for a trigger (e.g., an operating parameter, a specific application, a quality of user experience type) to enable the transmission of keep alive messages 230 that prevents UE 115-a from entering an idle mode. If a trigger is observed, AP layer 240 may then send a command to a PDCP layer 245 to enable a “keep connection mode state” at UE 115-a causing PDCP layer 245 to generate keep alive messages 230 (e.g., dummy PDCP PDUs) to send to base station 105-a (e.g., via an internet EPS bearer). In some cases, PDCP layer 245 may include or be associated with an SR or MAC layer. PDCP layer 245 may also start a keep alive timer at about the same time as sending an initial keep alive message 230 to base station 105-a. The keep alive timer may be set (e.g., keep alive times 235) based on a network traffic inactivity timer such that the keep alive timer expires before the network traffic inactivity timer. Alternatively, the keep alive timer may be set based on DRX timers (e.g., cycle length, ON duration, drxInactivityTimer). In one example, the network traffic inactivity timer may be preconfigured or set by base station 105 to be 10 seconds or more. In such cases, the keep alive timer may be set to 9 seconds or less (e.g., keep alive times 235-a or 235-b equal 9 seconds or less). At the time of expiration of the keep alive timer, PDCP layer 245 will generate a subsequent keep alive message 230, send it to base station 105-a (e.g., via the internet EPS bearer), and reset the keep alive timer. Additionally or alternatively, UE 115-a may transmit a dummy packet every cycle length K, where K is an integer in order to enter an awake state a plurality of times during a DRX cycle or to reduce the duration of time during which base station 105-a is waiting for the next awake occasion of a DRX cycle to send a downlink transmission.

If actual user data (e.g., non-dummy data or data packets 215) is transmitted or received at PDCP layer 245 (e.g., from the IP layer to be transmitted to base station 105-a or data packets received at the IP layer from base station 105-a) between generation and transmission of subsequent keep alive messages 230, PDCP layer 245 will reset the keep alive timer. Further, there may be a trigger (e.g., an operating parameter change, a lack of specific application, disable command) that may be used to disable or deactivate the “keep connection mode state” at UE 115-a. For instance, AP layer 240 may observe that the application that triggered activation of the “keep connection mode state” is no longer operating on UE 115-a and may therefore send a command to PDCP layer 245 to disable the “keep connection mode state” at UE 115-a. After receipt of such a command, PDCP layer 245 may stop the keep alive timer and cease generation of keep alive messages 230.

In the example of FIG. 2, AP layer 240 may initially detect a trigger that indicates UE 115-a needs to operate in a mode that maintains a connected state with base station 105-a. Consequently, UE 115-a (e.g., an IP layer of UE 115-a) may transmit a first data packet 215-a associated with the trigger to base station 105-a. However, UE 115-a may not transmit a second data packet 215-b until after an inactivity time 220. In some cases, inactivity time 220 may be greater than a length of time indicated by a network traffic inactivity timer. Accordingly, if UE 115-a does not transmit a keep alive message 230 before the network traffic inactivity timer expires, UE 115-a may enter an idle or sleep state.

In order to prevent UE 115-a from entering the idle or sleep state during inactivity time 220, PDCP layer 245 may transmit a first keep alive message 230-a after a first keep alive time 235-a associated with a keep alive timer expires. PDCP layer 245 may start first keep alive time 235-a after data packet 215-a was transmitted. Accordingly, after first keep alive message 230-a is transmitted, PDCP layer 245 may reset the keep alive timer and start a second keep alive time 235-b. If second keep alive time 235-b expires before a data packet 215 is transmitted or received, PDCP layer 245 may transmit a second keep alive message 230-b to base station 105-a. In some cases, keep alive times 235 may be shorter than the length of time indicated by the network traffic inactivity timer. Therefore, UE 115-a may remain in a connected state with base station 105-a because traffic activity occurs before the timer has a chance to expire. PDCP layer 245 may refrain from transmitting a third keep alive message 230 because UE 115-a may transmit or receive second data packet 215-b before a third keep alive time 235 expires. Additionally, after data packet 215-b is transmitted or received, AP layer 240 may detect that the trigger is no longer present, and PDCP layer 245 may stop generating keep alive messages 230.

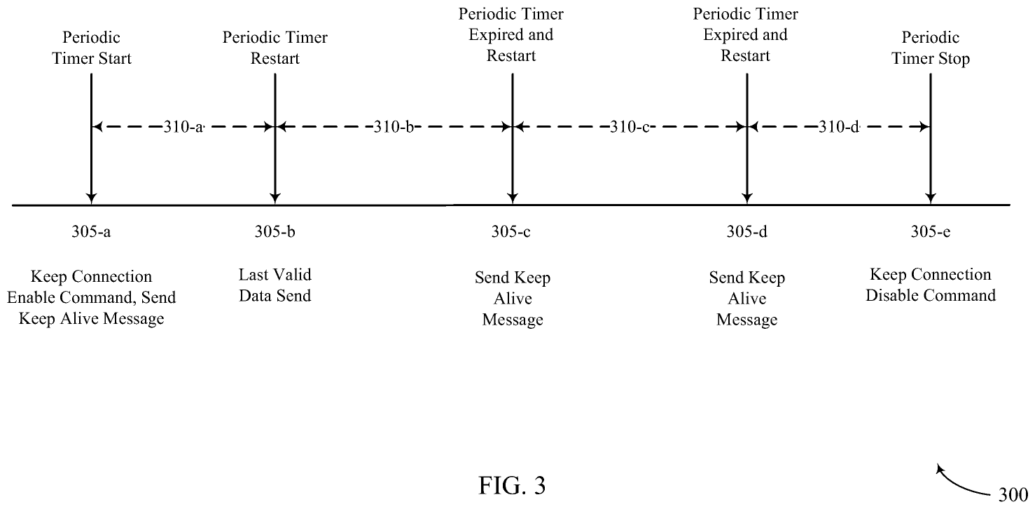

FIG. 3 illustrates an example of a timeline 300 that supports techniques for maintaining connected state in accordance with various aspects of the present disclosure. In some examples, timeline 300 may implement aspects of wireless communications systems 100 and 200. Timeline 300 may illustrate a number of times 305 for steps that a wireless device (e.g., a UE 115) may take for maintaining an RRC connected state with a network (e.g., a base station 105) to reduce latency as described herein.

At time 305-a, a first component of the wireless device (e.g., an AP layer) may enable a “keep connection mode” command for a second component of the wireless device (e.g., PDCP layer) based on monitoring for a specific scenario. For example, the specific scenario may include an application or quality of user experience type that necessitates low latency. Additionally, the second component may send a keep alive message (e.g., an RRC keep alive message) to the network. Accordingly, the second component may start a periodic timer (e.g., RRC keep alive timer).

At time 305-b, the wireless device may send a valid data transmission to the network. A duration 310-a between times 305-a and 305-b may be shorter than an expiration time for the periodic timer. Accordingly, the second component may restart the periodic timer after sending the data.

At time 305-c, the second component may send an RRC keep alive message to the network. A duration 310-b between times 305-b and 305-c may meet or exceed the expiration time for the periodic timer. In some cases, duration 310-b may be shorter than a network traffic inactivity timer. For example, duration 310-b may last nine seconds and the network traffic inactivity timer may last 10 or 10+s seconds. Since the periodic timer expires, the second component may send the RRC keep alive message at time 305-c to prevent the network inactivity timer from expiring. Accordingly, the second component may restart the periodic timer after sending the RRC keep alive message.

At time 305-d, the second component may send an RRC keep alive message to the network similar to time 305-c because the periodic timer may expire after a duration 310-c between times 305-c and 305-d. Accordingly, the second component may restart the periodic timer after sending the RRC keep alive message.

At time 305-e, the first component of the wireless device may detect that the wireless device has left the specific scenario and send a command to the second component to disable the “keep connection mode” command. In some cases, a time duration 310-d between times 305-d and 305-e may not reach the expiration time for the periodic timer, so the second component may not send an RRC keep alive message. Additionally, based on disabling the “keep connection mode,” the second component may stop the periodic timer.

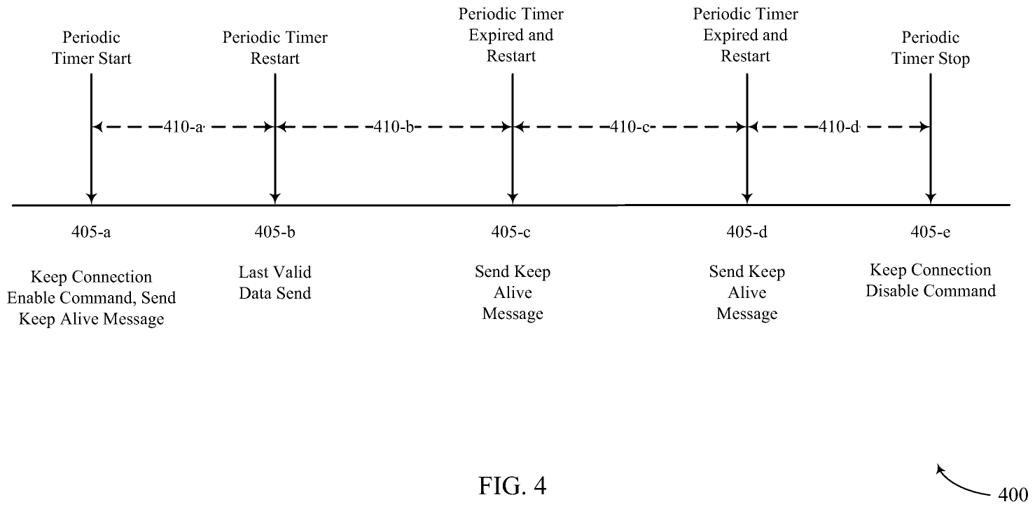

FIG. 4 illustrates an example of a timeline 400 that supports techniques for maintaining connected state in accordance with various aspects of the present disclosure. In some examples, timeline 400 may implement aspects of wireless communications systems 100 and 200. Timeline 400 may illustrate a number of times 405 for steps that a wireless device (e.g., a UE 115) may take for maintaining an awake sub-state of a DRX state with a network (e.g., a base station 105) to reduce latency as described herein.

At time 405-a, a first component of the wireless device (e.g., an AP layer) may enable a “keep connection mode” command for a second component of the wireless device (e.g., PDCP layer) based on monitoring for a specific scenario. For example, the specific scenario may include an application or quality of user experience type that necessitates low latency. Additionally, the second component may send a DRX keep alive message to the network. Accordingly, the second component may start a timer (e.g., a DRX keep awake timer).

At time 405-b, the wireless device may send a valid data transmission to the network. A duration 410-a between times 405-a and 405-b may be shorter than an expiration time for the timer. Accordingly, the second component may restart the timer after sending the data.

At time 405-c, the second component may send a keep alive message to the network. A duration 410-b between times 405-b and 405-c may meet or exceed the expiration time for the timer. In some cases, duration 410-b may be shorter than a drxInactivityTimer configured by the network based on the application or quality of user experience type. Since the periodic timer expires, the second component may send the keep alive message at time 405-c to prevent the drxInactivityTimer from expiring. Accordingly, the second component may restart the periodic timer after sending the keep alive message. Additionally or alternatively, the wireless device may enable a pattern of short sleep/awake sub-states by transmitting the keep alive message every cycle length K (e.g., drxCycleLength/K), where K is an integer in order to enter an awake state a plurality of times during a DRX cycle or to reduce the duration of time during which the network is waiting for the next ON occasion of a DRX cycle to send a downlink transmission.

At time 405-d, the second component may send a keep alive message to the network similar to time 405-c because the periodic timer may expire after a duration 410-c between times 405-c and 405-d. Accordingly, the second component may restart the periodic timer after sending the keep alive message.

At time 405-e, the first component of the wireless device may detect that the wireless device has left the specific scenario and send a command to the second component to disable the “keep connection mode” command. In some cases, a time duration 410-d between times 405-d and 405-e may not reach the expiration time for the periodic timer, so the second component may not send a keep alive message. Additionally, based on disabling the “keep connection mode,” the second component may stop the periodic timer.

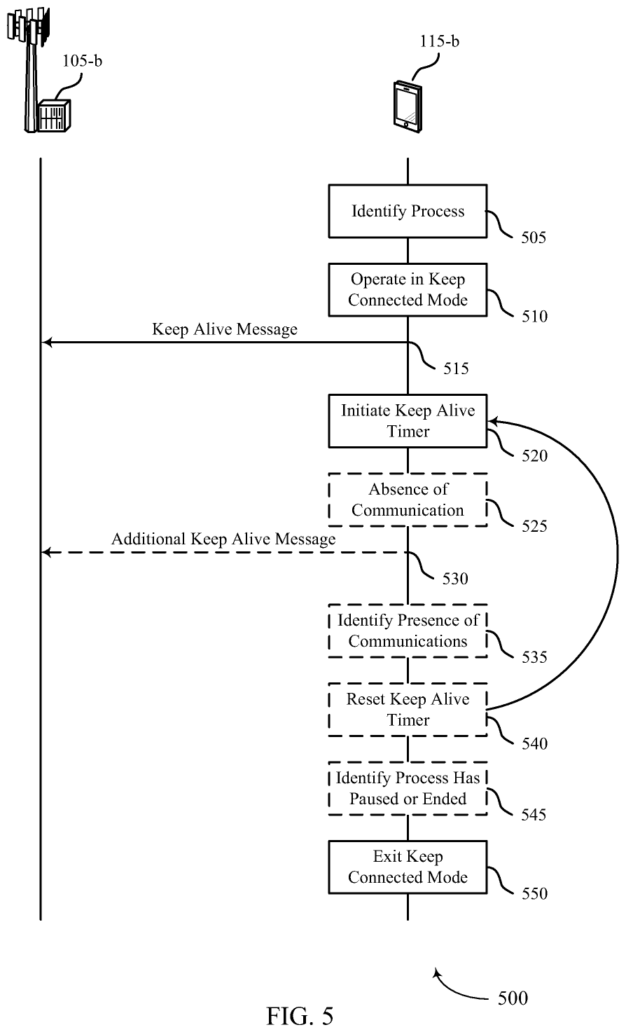

FIG. 5 illustrates an example of a process flow 500 that supports techniques for maintaining connected state in accordance with various aspects of the present disclosure. In some examples, process flow 500 may implement aspects of wireless communications systems 100 and 200. Process flow 500 may include a UE 115-b and a base station 105-b, which may be examples of UEs 115 and base stations 105 as described above with reference to FIGS. 1-3. In some cases, UE 115-b may be running a process and/or an application that requires low latency communications. As described herein, UE 115-b may operate in a connected mode state with base station 105-b to maintain a radio connection.

In the following description of the process flow 500, the operations between UE 115-b and base station 105-b may be performed in different orders or at different times. Certain operations may also be left out of the process flow 500, or other operations may be added to the process flow 500. It is to be understood that while UE 115-b is shown performing a number of the operations of process flow 500, any wireless device may perform the operations shown.

At 505, UE 115-b may identify that it is running a process that is associated with a quality of service type (e.g., quality of user experience type). In some cases, UE 115-b may monitor the process at an AP layer or at a modem layer (e.g., DS layer) and determine the quality of service type associated with the process. Additionally or alternatively, UE 115-b may receive an indication that the process is running via a low latency service API. In some cases, the quality of service type may include a communications latency level that satisfies (e.g., is below) a latency threshold, where the communications latency level, the latency threshold, or both are associated with mobile terminated traffic.

At 510, UE 115-b may operate in a mode for maintaining a connected state between UE 115-b and base station 105-b based on the quality of service type.

At 515, UE 115-b may transmit, to base station 105-b, a keep alive message based on operation in the connected state mode, where the keep alive message ensures that a radio connection between UE 115-b and base station 105-b remains available. In some cases, transmitting the keep alive message may include transmitting at least one of an activity ping, a dummy PDCP PDU, fake data, an SR, or combinations thereof. Additionally or alternatively, UE 115-b may generate a dummy PDCP PDU on an interface for transmission as the keep alive message.

At 520, UE 115-b may initiate a keep alive timer at the time of the keep alive message transmission. Accordingly, UE 115-b may perform the operations at 415 and 420 simultaneously. In some cases, the keep alive timer may have a period that is less than a network traffic inactivity time period. Alternatively, in some cases, the keep alive timer may have a period that is less than an inactivity timer associated with a DRX cycle (e.g., a drxInactivityTimer). Additionally or alternatively, the keep alive timer has a period that is less than a DRX cycle length, for example, less than a sub-cycle length within a DRX cycle (e.g., every cycle length K in drxCycleLength such that UE 115-b may enter an awake state a plurality of times in a DRX cycle).

At 525, UE 115-b may identify an absence of communications over the radio connection between UE 115-b and base station 105-b for a first amount of time. Additionally or alternatively, UE 115-b may identify an absence of communications from UE 115-b to base station 105-b during a duration of the keep alive timer.

At 530, based on the absence of communications at 525, UE 115-b may transmit one or more additional keep alive messages. Additionally or alternatively, UE 115-b may transmitting an additional keep alive message to base station 105-b upon expiration of the keep alive timer.

Alternatively to identifying an absence of communications at 525, UE 115-b may identify a presence of communications between UE 115-b and base station 105-b during a duration of the keep alive timer at 535.

At 540, based on either identifying an absence of communications at 525 and transmitting an additional keep alive message at 530 or identifying a presence of communications at 535, UE 115-b may reset the keep alive timer. UE 115-b may continue to monitor the communications and consequently transmit additional keep alive messages and/or reset the keep alive timer while operating in the connected state.

At 545, UE 115-b may identify that the process started at 505 has paused or terminated. In some cases, UE 115-b may receive, from an API, an indication of a mode change from the mode for maintaining the connected state (e.g., a disable command).

At 550, UE 115-b may exit the mode for maintaining the connected state between UE 115-b and base station 105-b based on the identification at 545.

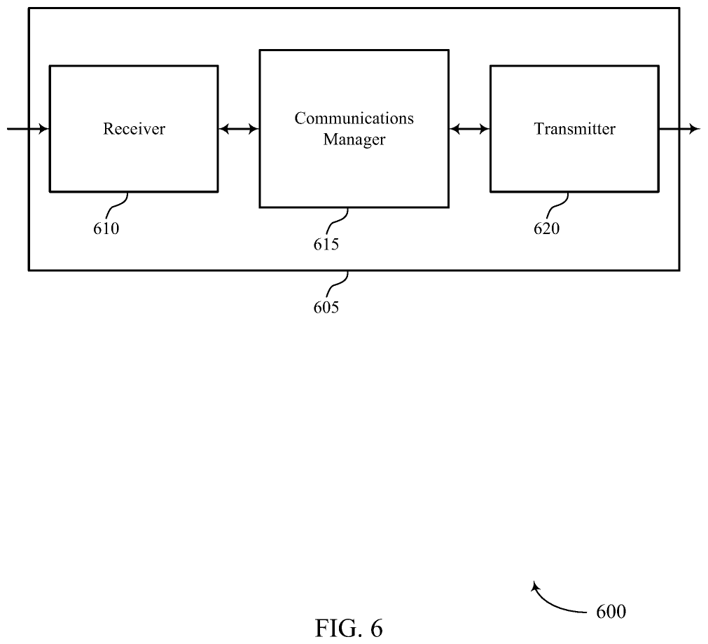

FIG. 6 shows a block diagram 600 of a wireless device 605 that supports techniques for maintaining connected state in accordance with aspects of the present disclosure. Wireless device 605 may be an example of aspects of a UE 115 as described herein. Wireless device 605 may include receiver 610, communications manager 615, and transmitter 620. Wireless device 605 may also include a processor. Each of these components may be in communication with one another (e.g., via one or more buses).

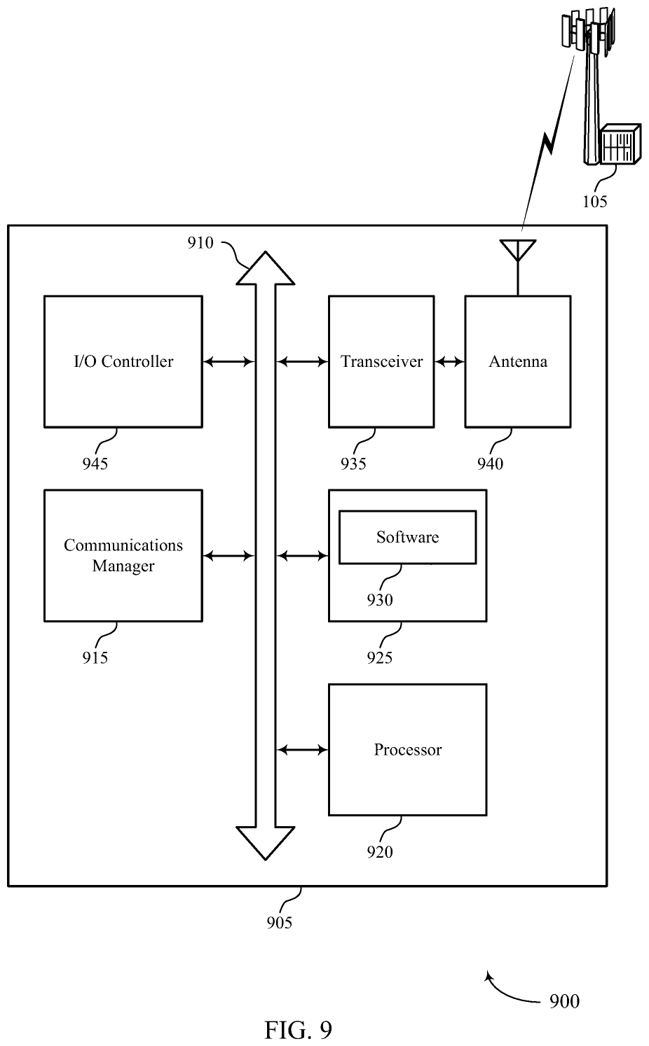

Receiver 610 may receive information such as packets, user data, or control information associated with various information channels (e.g., control channels, data channels, and information related to techniques for maintaining connected mode state, etc.). Information may be passed on to other components of the device. The receiver 610 may be an example of aspects of the transceiver 935 described with reference to FIG. 9. The receiver 610 may utilize a single antenna or a set of antennas.

Communications manager 615 may be an example of aspects of the communications manager 915 described with reference to FIG. 9. Communications manager 615 and/or at least some of its various sub-components may be implemented in hardware, software executed by a processor, firmware, or any combination thereof. If implemented in software executed by a processor, the functions of the communications manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 615 and/or at least some of its various sub-components may be physically located at various positions, including being distributed such that portions of functions are implemented at different physical locations by one or more physical devices. In some examples, communications manager 615 and/or at least some of its various sub-components may be a separate and distinct component in accordance with various aspects of the present disclosure. In other examples, communications manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 615 may identify that the UE is running a process that is associated with a quality of service type. Communications manager 615 may operate in a mode for maintaining a connected state between the UE and a network based on the quality of service type, and transmit, to the network, a keep alive message based on operation of the UE in the mode, where the keep alive message ensures that a radio connection between the UE and the network remains available.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may utilize a single antenna or a set of antennas.

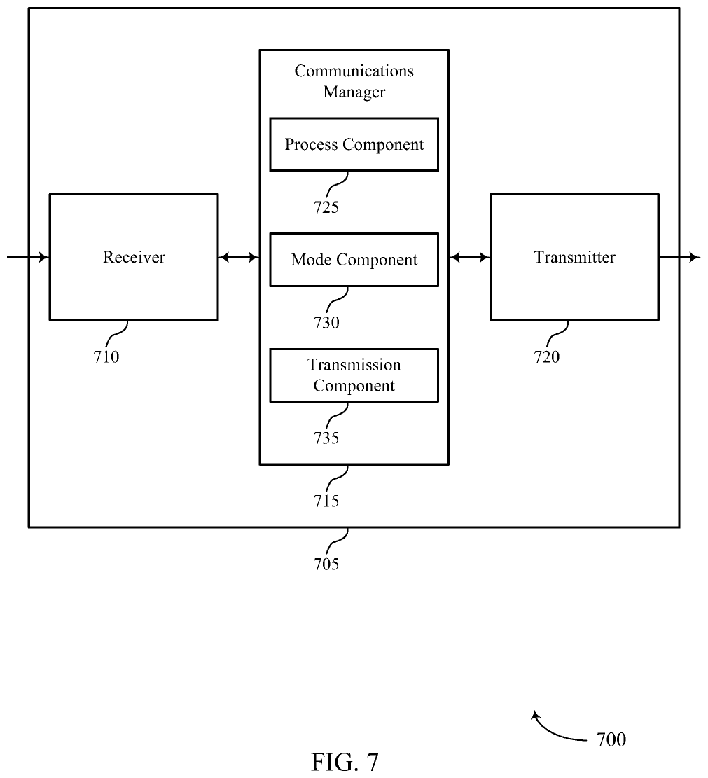

FIG. 7 shows a block diagram 700 of a wireless device 705 that supports techniques for maintaining connected state in accordance with aspects of the present disclosure. Wireless device 705 may be an example of aspects of a wireless device 605 or a UE 115 as described with reference to FIG. 6. Wireless device 705 may include receiver 710, communications manager 715, and transmitter 720. Wireless device 705 may also include a processor. Each of these components may be in communication with one another (e.g., via one or more buses).

Receiver 710 may receive information such as packets, user data, or control information associated with various information channels (e.g., control channels, data channels, and information related to techniques for maintaining connected state, etc.). Information may be passed on to other components of the device. The receiver 710 may be an example of aspects of the transceiver 935 described with reference to FIG. 9. The receiver 710 may utilize a single antenna or a set of antennas.

Communications manager 715 may be an example of aspects of the communications manager 915 described with reference to FIG. 9. Communications manager 715 may also include process component 725, mode component 730, and transmission component 735.

Process component 725 may identify that the UE is running a process that is associated with a quality of service type and identify that the process has paused or terminated. In some cases, identifying that the UE is running the process includes: monitoring the process at an AP layer or at a modem layer and determining the quality of service type associated with the process. In some cases, identifying that the UE is running the process includes: receiving an indication that the UE is running the process via a low latency service API. In some cases, the quality of service type includes a communications latency level that satisfies (e.g., is below) a latency threshold. In some cases, the communications latency level, the latency threshold, or both are associated with mobile terminated traffic.

Mode component 730 may operate in a mode for maintaining a connected state between the UE and a network based on the quality of service type, exit the mode for maintaining the connected state between the UE and the network, receive, from an API, an indication of a mode change from the mode for maintaining the connected state, and exit the mode for maintaining the connected state between the UE and the network.

Transmission component 735 may transmit, to the network, a keep alive message based on operation of the UE in the mode, where the keep alive message ensures that a radio connection between the UE and the network remains available, transmit one or more additional keep alive messages based on the absence of communications, and transmit an additional keep alive message to the network upon expiration of the keep alive timer. In some cases, transmitting the keep alive message includes: transmitting, to the network, at least one of an activity ping, a dummy PDCP PDU, fake data, an SR, or combinations thereof.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may utilize a single antenna or a set of antennas.

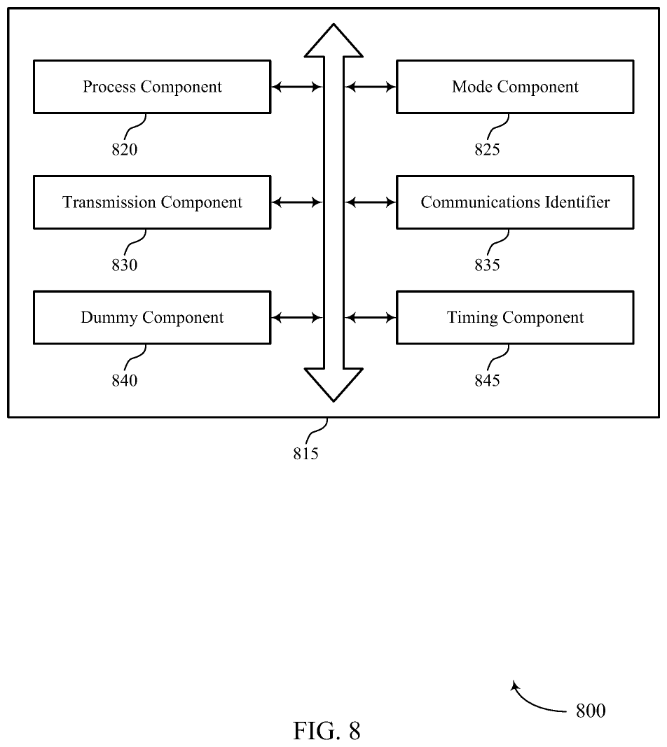

FIG. 8 shows a block diagram 800 of a communications manager 815 that supports techniques for maintaining connected state in accordance with aspects of the present disclosure. The communications manager 815 may be an example of aspects of a communications manager 615, a communications manager 715, or a communications manager 915 described with reference to FIGS. 6, 7, and 9. The communications manager 815 may include process component 820, mode component 825, transmission component 830, communications identifier 835, dummy component 840, and timing component 845. Each of these modules may communicate, directly or indirectly, with one another (e.g., via one or more buses).

Process component 820 may identify that the UE is running a process and/or application that is associated with a quality of service type and identify that the process has paused or terminated. In some cases, identifying that the UE is running the process and/or application includes: monitoring the process at an AP layer or at a modem layer and determining the quality of service type associated with the process. In some cases, identifying that the UE is running the process includes: receiving an indication that the UE is running the process via a low latency service API. In some cases, the quality of service type includes a communications latency level that satisfies (e.g., is below) a latency threshold. In some cases, the communications latency level, the latency threshold, or both are associated with mobile terminated traffic.

Mode component 825 may operate in a mode for maintaining a connected state between the UE and a network based on the quality of service type, exit the mode for maintaining the connected state between the UE and the network, receive, from an API, an indication of a mode change from the mode for maintaining the connected state, and exit the mode for maintaining the connected state between the UE and the network.

Transmission component 830 may transmit, to the network, a keep alive message based on operation of the UE in the mode, where the keep alive message ensures that a radio connection between the UE and the network remains available, transmit one or more additional keep alive messages based on the absence of communications, and transmit an additional keep alive message to the network upon expiration of the keep alive timer. In some cases, transmitting the keep alive message includes: transmitting, to the network, at least one of an activity ping, a dummy PDCP PDU, fake data, an SR, or combinations thereof.

Communications identifier 835 may identify an absence of communications over the radio connection between the UE and the network for a first amount of time, identify an absence of communications from the UE to the network during a duration of the keep alive timer, and identify a presence of communications between the UE and the network during a duration of the keep alive timer.

Dummy component 840 may generate a dummy PDCP PDU on an interface for transmission as the keep alive message.

Timing component 845 may initiate a keep alive timer at a time of the transmission, reset the keep alive timer upon transmission of the additional keep alive message, and reset the keep alive timer based on the presence of communications between the UE and the network. In some cases, the keep alive timer has a period that is less than a network traffic inactivity time period. In some cases, the keep alive timer has a period that is less than an inactivity timer associated with a DRX cycle. In some cases, the keep alive timer has a period that is less than a DRX cycle length or less than a sub-cycle length within a DRX cycle.

FIG. 9 shows a diagram of a system 900 including a device 905 that supports techniques for maintaining connected state in accordance with aspects of the present disclosure. Device 905 may be an example of or include the components of wireless device 605, wireless device 705, or a UE 115 as described above, e.g., with reference to FIGS. 6 and 7. Device 905 may include components for bi-directional voice and data communications including components for transmitting and receiving communications, including communications manager 915, processor 920, memory 925, software 930, transceiver 935, antenna 940, and I/O controller 945. These components may be in electronic communication via one or more buses (e.g., bus 910). Device 905 may communicate wirelessly with one or more base stations 105.

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting techniques for maintaining connected mode state).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support techniques for maintaining connected mode state. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with device 905 via I/O controller 945 or via hardware components controlled by I/O controller 945.

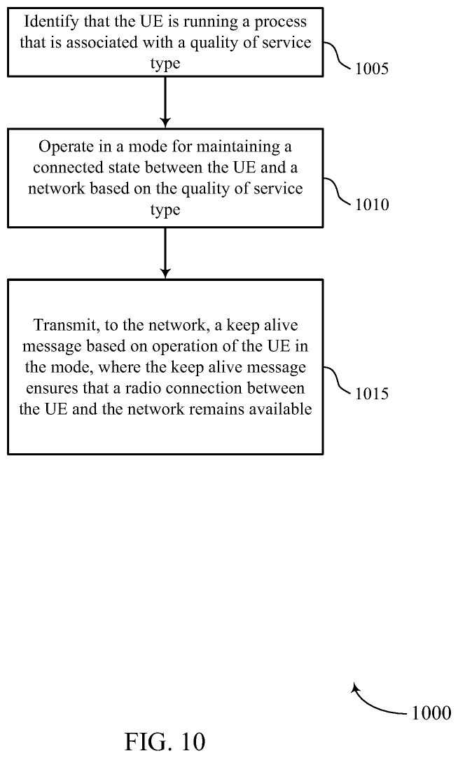

FIG. 10 shows a flowchart illustrating a method 1000 for techniques for maintaining connected state in accordance with aspects of the present disclosure. The operations of method 1000 may be implemented by a UE 115 or its components as described herein. For example, the operations of method 1000 may be performed by a communications manager as described with reference to FIGS. 6 through 9. In some examples, a UE 115 may execute a set of codes to control the functional elements of the device to perform the functions described below. Additionally or alternatively, the UE 115 may perform aspects of the functions described below using special-purpose hardware.

At 1005 the UE 115 may identify that the UE is running a process that is associated with a quality of service type. The operations of 1005 may be performed according to the methods described herein. In certain examples, aspects of the operations of 1005 may be performed by a process component as described with reference to FIGS. 6 through 9.

At 1010 the UE 115 may operate in a mode for maintaining a connected state between the UE and a network based on the quality of service type. The operations of 1010 may be performed according to the methods described herein. In certain examples, aspects of the operations of 1010 may be performed by a mode component as described with reference to FIGS. 6 through 9.

At 1015 the UE 115 may transmit, to the network, a keep alive message based on operation of the UE in the mode, where the keep alive message ensures that a radio connection between the UE and the network remains available. The operations of 1015 may be performed according to the methods described herein. In certain examples, aspects of the operations of 1015 may be performed by a transmission component as described with reference to FIGS. 6 through 9.

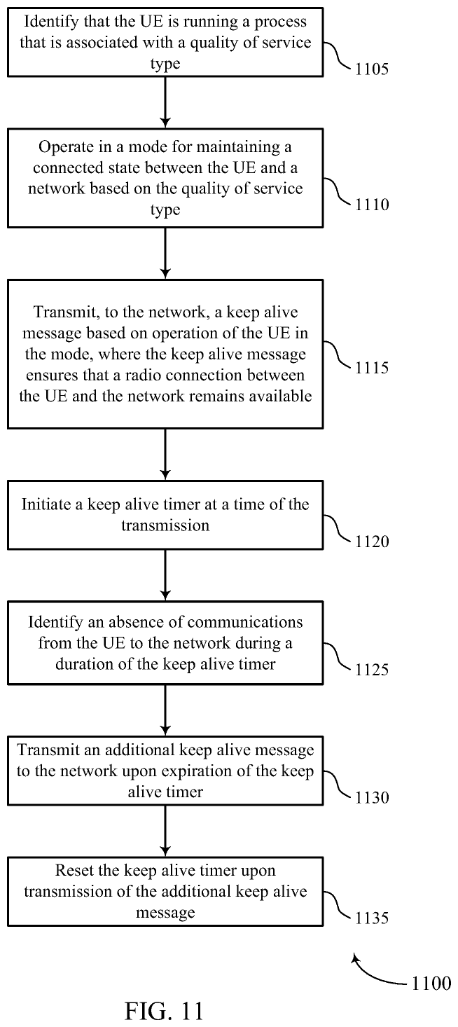

FIG. 11 shows a flowchart illustrating a method 1100 for techniques for maintaining connected state in accordance with aspects of the present disclosure. The operations of method 1100 may be implemented by a UE 115 or its components as described herein. For example, the operations of method 1100 may be performed by a communications manager as described with reference to FIGS. 6 through 9. In some examples, a UE 115 may execute a set of codes to control the functional elements of the device to perform the functions described below. Additionally or alternatively, the UE 115 may perform aspects of the functions described below using special-purpose hardware.

At 1105 the UE 115 may identify that the UE is running a process that is associated with a quality of service type. The operations of 1105 may be performed according to the methods described herein. In certain examples, aspects of the operations of 1105 may be performed by a process component as described with reference to FIGS. 6 through 9.

At 1110 the UE 115 may operate in a mode for maintaining a connected state between the UE and a network based on the quality of service type. The operations of 1110 may be performed according to the methods described herein. In certain examples, aspects of the operations of 1110 may be performed by a mode component as described with reference to FIGS. 6 through 9.

At 1115 the UE 115 may transmit, to the network, a keep alive message based on operation of the UE in the mode, where the keep alive message ensures that a radio connection between the UE and the network remains available. The operations of 1115 may be performed according to the methods described herein. In certain examples, aspects of the operations of 1115 may be performed by a transmission component as described with reference to FIGS. 6 through 9.

At 1120 the UE 115 may initiate a keep alive timer at a time of the transmission. The operations of 1120 may be performed according to the methods described herein. In certain examples, aspects of the operations of 1120 may be performed by a timing component as described with reference to FIGS. 6 through 9.

At 1125 the UE 115 may identify an absence of communications from the UE to the network during a duration of the keep alive timer. The operations of 1125 may be performed according to the methods described herein. In certain examples, aspects of the operations of 1125 may be performed by a communications identifier as described with reference to FIGS. 6 through 9.

At 1130 the UE 115 may transmit an additional keep alive message to the network upon expiration of the keep alive timer. The operations of 1130 may be performed according to the methods described herein. In certain examples, aspects of the operations of 1130 may be performed by a transmission component as described with reference to FIGS. 6 through 9.

At 1135 the UE 115 may reset the keep alive timer upon transmission of the additional keep alive message. The operations of 1135 may be performed according to the methods described herein. In certain examples, aspects of the operations of 1135 may be performed by a timing component as described with reference to FIGS. 6 through 9.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
identifying that the UE is running a process that is associated with a quality of service type;
operating in a mode for maintaining a connected state between the UE and a network based at least in part on the quality of service type; and
transmitting, to the network, a keep alive message based at least in part on operation of the UE in the mode, wherein the keep alive message ensures that a radio connection between the UE and the network remains available.

2. The method of claim 1, further comprising:
identifying an absence of communications over the radio connection between the UE and the network for a first amount of time; and
transmitting one or more additional keep alive messages based at least in part on the absence of communications.

3. The method of claim 1, wherein transmitting the keep alive message comprises:
transmitting, to the network, at least one of an activity ping, a dummy packet data convergence protocol (PDCP) protocol data unit (PDU), fake data, a scheduling request (SR), or combinations thereof.

4. The method of claim 1, wherein identifying that the UE is running the process comprises:
monitoring the process at an application processor (AP) layer or at a modem layer and determining the quality of service type associated with the process.

5. The method of claim 1, wherein identifying that the UE is running the process comprises:
receiving an indication that the UE is running the process via a low latency service application programming interface (API).

6. The method of claim 1, further comprising:
generating a dummy packet data convergence protocol (PDCP) protocol data unit (PDU) on an interface for transmission as the keep alive message.

7. The method of claim 1, wherein the quality of service type includes a communications latency level that satisfies a latency threshold.

8. The method of claim 7, wherein the communications latency level, the latency threshold, or both are associated with mobile terminated traffic.

9. The method of claim 1, further comprising:
initiating a keep alive timer at a time of the transmission.

10. The method of claim 9, wherein the keep alive timer has a period that is less than a network traffic inactivity time period.

11. The method of claim 9, wherein the keep alive timer has a period that is less than an inactivity timer associated with a discontinuous reception (DRX) cycle.

12. The method of claim 9, wherein the keep alive timer has a period that is less than a DRX cycle length.

13. The method of claim 9, further comprising:
identifying an absence of communications between the UE and the network during a duration of the keep alive timer;
transmitting an additional keep alive message to the network upon expiration of the keep alive timer; and
resetting the keep alive timer upon transmission of the additional keep alive message.

14. The method of claim 9, further comprising:
identifying a presence of communications between the UE and the network during a duration of the keep alive timer; and
resetting the keep alive timer based at least in part on the presence of communications between the UE and the network.

15. The method of claim 1, further comprising:
identifying that the process has paused or terminated; and
exiting the mode for maintaining the connected state between the UE and the network.

16. The method of claim 1, further comprising:
receiving, from an application programming interface (API), an indication of a mode change from the mode for maintaining the connected state; and
exiting the mode for maintaining the connected state between the UE and the network.

17. An apparatus for wireless communications, comprising:
means for identifying that the UE is running a process that is associated with a quality of service type;
means for operating in a mode for maintaining a connected state between the UE and a network based at least in part on the quality of service type; and
means for transmitting, to the network, a radio resource control (RRC) keep alive message based at least in part on operation of the UE in the mode, wherein the keep alive message ensures that a radio connection between the UE and the network remains available.

18. The apparatus of claim 17, further comprising:
means for identifying an absence of communications over the radio connection between the UE and the network for a first amount of time; and
means for transmitting one or more additional keep alive messages based at least in part on the absence of communications.

19. The apparatus of claim 17, wherein the means for transmitting the keep alive message comprises:
means for transmitting, to the network, at least one of an activity ping, a dummy packet data convergence protocol (PDCP) protocol data unit (PDU), fake data, a scheduling request (SR), or combinations thereof.

20. The apparatus of claim 17, wherein the means for identifying that the UE is running the process comprises:
means for monitoring the process at an application processor (AP) layer or at a modem layer and determining the quality of service type associated with the process.

21. The apparatus of claim 17, wherein the means for identifying that the UE is running the process comprises:
means for receiving an indication that the UE is running the process via a low latency service application programming interface (API).

22. The apparatus of claim 17, further comprising:
means for generating a dummy packet data convergence protocol (PDCP) protocol data unit (PDU) on an interface for transmission as the keep alive message.

23. The apparatus of claim 17, wherein the quality of service type includes a communications latency level that satisfies a latency threshold.

24. The apparatus of claim 23, wherein the communications latency level, the latency threshold, or both are associated with mobile terminated traffic.

25. The apparatus of claim 17, further comprising:
means for initiating a keep alive timer at a time of the transmission.

26. The apparatus of claim 25, wherein the keep alive timer has a period that is less than a network traffic inactivity time period.

27. The apparatus of claim 25, wherein the keep alive timer has a period that is less than an inactivity timer associated with a discontinuous reception (DRX) cycle.

28. The apparatus of claim 25, wherein the keep alive timer has a period that is less than a DRX cycle length.

29. The apparatus of claim 25, further comprising:
means for identifying an absence of communications between the UE and the network during a duration of the keep alive timer;
means for transmitting an additional keep alive message to the network upon expiration of the keep alive timer; and
means for resetting the keep alive timer upon transmission of the additional keep alive message.

30. The apparatus of claim 25, further comprising:
means for identifying a presence of communications between the UE and the network during a duration of the keep alive timer; and
means for resetting the keep alive timer based at least in part on the presence of communications between the UE and the network.

31. The apparatus of claim 17, further comprising:
means for identifying that the process has paused or terminated; and
means for exiting the mode for maintaining the connected state between the UE and the network.

32. The apparatus of claim 17, further comprising:
means for receiving, from an application programming interface (API), an indication of a mode change from the mode for maintaining the connected state; and
means for exiting the mode for maintaining the connected state between the UE and the network.

33. An apparatus for wireless communications, comprising:
a processor;
memory in electronic communication with the processor; and
instructions stored in the memory and executable by the processor to cause the apparatus to:
identify that the UE is running a process that is associated with a quality of service type;
operate in a mode for maintaining a connected state between the UE and a network based at least in part on the quality of service type; and
transmit, to the network, a radio resource control (RRC) keep alive message based at least in part on operation of the UE in the mode, wherein the keep alive message ensures that a radio connection between the UE and the network remains available.

34. The apparatus of claim 33, wherein the instructions are further executable by the processor to cause the apparatus to:
identify an absence of communications over the radio connection between the UE and the network for a first amount of time; and
transmit one or more additional keep alive messages based at least in part on the absence of communications.

35. The apparatus of claim 33, wherein the instructions to transmit the keep alive message are executable by the processor to cause the apparatus to:
transmit, to the network, at least one of an activity ping, a dummy packet data convergence protocol (PDCP) protocol data unit (PDU), fake data, a scheduling request (SR), or combinations thereof.

36. The apparatus of claim 33, wherein the instructions to identify that the UE is running the process are executable by the processor to cause the apparatus to:
monitor the process at an application processor (AP) layer or at a modem layer and determining the quality of service type associated with the process.

37. The apparatus of claim 33, wherein the instructions to identify that the UE is running the process are executable by the processor to cause the apparatus to:
receive an indication that the UE is running the process via a low latency service application programming interface (API).

38. The apparatus of claim 33, wherein the instructions are further executable by the processor to cause the apparatus to:
generate a dummy packet data convergence protocol (PDCP) protocol data unit (PDU) on an interface for transmission as the keep alive message.

39. The apparatus of claim 33, wherein the quality of service type includes a communications latency level that satisfies a latency threshold.

40. The apparatus of claim 39, wherein the communications latency level, the latency threshold, or both are associated with mobile terminated traffic.

41. The apparatus of claim 33, wherein the instructions are further executable by the processor to cause the apparatus to:
initiate a keep alive timer at a time of the transmission.

42. The apparatus of claim 41, wherein the keep alive timer has a period that is less than a network traffic inactivity time period.

43. The apparatus of claim 41, wherein the keep alive timer has a period that is less than an inactivity timer associated with a discontinuous reception (DRX) cycle.

44. The apparatus of claim 41, wherein the keep alive timer has a period that is less than a DRX cycle length.

45. The apparatus of claim 41, wherein the instructions are further executable by the processor to cause the apparatus to:
identify an absence of communications between the UE and the network during a duration of the keep alive timer;
transmit an additional keep alive message to the network upon expiration of the keep alive timer; and
reset the keep alive timer upon transmission of the additional keep alive message.

46. The apparatus of claim 41, wherein the instructions are further executable by the processor to cause the apparatus to:
identify a presence of communications between the UE and the network during a duration of the keep alive timer; and
reset the keep alive timer based at least in part on the presence of communications between the UE and the network.

47. The apparatus of claim 33, wherein the instructions are further executable by the processor to cause the apparatus to:
identify that the process has paused or terminated; and
exit the mode for maintaining the connected state between the UE and the network.

48. The apparatus of claim 33, wherein the instructions are further executable by the processor to cause the apparatus to:
receive, from an application programming interface (API), an indication of a mode change from the for maintaining the connected state; and
exit the mode for maintaining the connected state between the UE and the network.

49. A non-transitory computer-readable medium storing code for wireless communications, the code comprising instructions executable by a processor to:
identify that the UE is running a process that is associated with a quality of service type;
operate in a mode for maintaining a connected state between the UE and a network based at least in part on the quality of service type; and
transmit, to the network, a radio resource control (RRC) keep alive message based at least in part on operation of the UE in the mode, wherein the keep alive message ensures that a radio connection between the UE and the network remains available.

50. The non-transitory computer-readable medium of claim 49, wherein the instructions are further executable by the processor to:
identify an absence of communications over the radio connection between the UE and the network for a first amount of time; and
transmit one or more additional keep alive messages based at least in part on the absence of communications.

51. The non-transitory computer-readable medium of claim 49, wherein the instructions to transmit the keep alive message are executable by the processor to:
transmit, to the network, at least one of an activity ping, a dummy packet data convergence protocol (PDCP) protocol data unit (PDU), fake data, a scheduling request (SR), or combinations thereof.

52. The non-transitory computer-readable medium of claim 49, wherein the instructions to identify that the UE is running the process are executable by the processor to:
monitor the process at an application processor (AP) layer or at a modem layer and determining the quality of service type associated with the process.

53. The non-transitory computer-readable medium of claim 49, wherein the instructions to identify that the UE is running the process are executable by the processor to:
receive an indication that the UE is running the process via a low latency service application programming interface (API).

54. The non-transitory computer-readable medium of claim 49, wherein the instructions are further executable by the processor to:
generate a dummy packet data convergence protocol (PDCP) protocol data unit (PDU) on an interface for transmission as the keep alive message.

55. The non-transitory computer-readable medium of claim 49, wherein the quality of service type includes a communications latency level that satisfies a latency threshold.

56. The non-transitory computer-readable medium of claim 55, wherein the communications latency level, the latency threshold, or both are associated with mobile terminated traffic.

57. The non-transitory computer-readable medium of claim 49, wherein the instructions are further executable by the processor to:
initiate a keep alive timer at a time of the transmission.

58. The non-transitory computer-readable medium of claim 57, wherein the keep alive timer has a period that is less than a network traffic inactivity time period.

59. The non-transitory computer-readable medium of claim 57, wherein the keep alive timer has a period that is less than an inactivity timer associated with a discontinuous reception (DRX) cycle.

60. The non-transitory computer-readable medium of claim 57, wherein the keep alive timer has a period that is less than a DRX cycle length.

61. The non-transitory computer-readable medium of claim 57, wherein the instructions are further executable by the processor to:
identify an absence of communications between the UE and the network during a duration of the keep alive timer;
transmit an additional keep alive message to the network upon expiration of the keep alive timer; and
reset the keep alive timer upon transmission of the additional keep alive message.

62. The non-transitory computer-readable medium of claim 57, wherein the instructions are further executable by the processor to:
identify a presence of communications between the UE and the network during a duration of the keep alive timer; and
reset the keep alive timer based at least in part on the presence of communications between the UE and the network.

63. The non-transitory computer-readable medium of claim 49, wherein the instructions are further executable by the processor to:
identify that the process has paused or terminated; and
exit the mode for maintaining the connected state between the UE and the network.

64. The non-transitory computer-readable medium of claim 49, wherein the instructions are further executable by the processor to:
receive, from an application programming interface (API), an indication of a mode change from the mode for maintaining the connected state; and
exit the mode for maintaining the connected state between the UE and the network.

65. (canceled)
